(19) United States
(12) Patent Application Publication
(10) Pub. No.: US 2011/0208552 A1
(43) Pub. Date: Aug. 25, 2011

(54) LEVERAGING BUSINESS SERVICES FOR SOA SOLUTION DEVELOPMENT

(75) Inventors: Ali P. Arsanjani, Fairfield, IA (US); Shuvanker Ghosh, Tampa, FL (US); Ahamed Jalaldeen, Karnataka (IN); Siddharth N. Purohit, Allen, TX (US)

(73) Assignee: International Business Machines Corporation, Armonk, NY (US)

(21) Appl. No.: 12/712,427

(22) Filed: Feb. 25, 2010

(51) Int. Cl. G06Q 10/00

(52) U.S. Cl. 705/7.11

(57) ABSTRACT

The present invention comprises a method for treating business services identified in CBM as service categories, a top-down concept prior to identification of actual services—of SOA. It provides new algorithms to group the services identified from process maps by business services and services categories. It reconciles a granularity gap between business capabilities that are offered as business services at business architecture level and SOA services at the IT level. The present invention provides a tooling enhancement to map business process elements (process, sub-process, task) and business activities to suitable business services, new algorithms to group services identified from process maps by business services, an efficient way of leveraging Business Services for SOA solution development and an elimination of manual effort, time, and inconsistent approaches to group the services identified from process maps.

### FIELD OF THE INVENTION

The present invention relates to a method or system of leveraging business services for Service Oriented Architecture (SOA) solution development.

### BACKGROUND OF THE INVENTION

There is an absence of methods and tools to leverage business services identified in Component Business Modeling (CBM) for SOA solution development. There are no known solutions. There is a need for a new solution.

Therefore, there is a need to solve the problems associated as described above.

### SUMMARY OF THE INVENTION

The present invention provides a system and at least one method to leverage business services identified in CBM for SOA solution development.

The present invention may further comprise a method for leveraging business services for Service Oriented Architecture (SOA) solution development in a system having a business component, such as a Component Business Modeling Component (CBMC), one or more business services, such as a Component Business Modeling (CBM) and a course-granular functional area, the business component may have one or more business services, the method comprising connecting the course-granular functional area to a fine-granular functional area, connecting the fine-granular functional area to a service group that may have one or more service, to one or more processes, to one or more sub-processes and to one or more tasks, and mapping the one or more processes and one or more sub-processes to one or more corresponding business components.

The present invention may further provide a method for leveraging business services for Service Oriented Architecture (SOA) solution development in a system having a business component, such as a Component Business Modeling Component (CBMC), one or more business services, such as a Component Business Modeling (CBM), has one or more business services, such as CBM and a course-granular functional area, business component having one or more business services, the method comprising retrieving a list of candidate services in the current SOA model, examining each candidate service, verifying identification of candidate service, decomposing the method and identifying the business component corresponding to the candidate service.

The present invention further may provide a computer program product for implementing a method for leveraging business services for Service Oriented Architecture (SOA) solution development in a system having a business component, such as a Component Business Modeling Component (CBMC), has one or more course-granular Component Business Modeling business services (CBM) and a functional area, the business component may have one or more business services, the computer program product comprising a computer readable storage media, program instructions to connect the course-granular functional area to fine-granular functional area, program instructions to connect the fine-granular functional area to a service group that may have one or more service, to one or more processes, to one or more sub-processes and to one or more tasks and program instructions to map one or more business processes and one or more sub-processes to one or more corresponding business components, and wherein the program instructions are stored on the computer readable storage media.

The present invention may further provide a method for deploying a computing infrastructure comprising integrating computer-readable code into a computing system, wherein the code in combination with the computing system is capable of leveraging business services for a Service Oriented Architecture (SOA) model solution development in a system having a business component, such as a Component Business Modeling Component (CBMC), has one or more course-granular Component Business Modeling business services (CBM) and a course-granular functional area, the business component having one or more business services, the method comprising retrieving a list of candidate services in a current SOA model, examining each candidate service, verifying identification of a candidate service, decomposing the method and identifying the business component corresponding to the candidate service.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a data processing system suitable for implementing an embodiment of the present invention.

FIG. 2 shows a network for implementing an embodiment of the present invention.

FIG. 3 illustrates an embodiment of a system of the present invention.

FIG. 4 illustrates a method for implementing the system and method of the present invention.

FIG. 5 illustrates another embodiment of the method of the present invention.

FIG. 6 illustrates another embodiment of the method of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE INVENTION

The present invention comprises a system and method for leveraging business services for SOA solution development.

In the present invention, business services identified in CBM are treated as a Service Category utilizing a top-down concept prior to identification of actual services of SOA.

It further provides new algorithms to group the services identified from process maps by Business Services/Services Categories.

The present invention reconciles a granularity gap between business capabilities that are offered as Business Services at business architecture level and SOA services at the information technology (IT) level.

It provides a tooling enhancement to map business process elements (process, sub-process, task) and business activities to suitable Business Services and provides new algorithms to group services identified from process maps by Business Services.

It provides such advantages as providing an efficient way of leveraging Business Services for SOA solution development, elimination of manual effort, time and inconsistent approaches to group the services identified from process maps and providing new user interfaces to establish mapping between Business Processes and Business Services, Business Activities and Business Services, Implementation of algorithms in UML based SOA modeling tools to group services identified from process maps by Business Services.

Here are some abbreviations that are used in this specification:

| | |
|---|---|
| CBM | Component Business Modeling |
| RSA | Rational Software Architect |
| RSM | Rational Software Modeler |
| SOA | Service Oriented Architecture |
| SOMA | Service Oriented Modeling and Architecture |
| SOMA-ME | SOMA Modeling Environment |
| UML | Unified Modeling Language |

Component Business Model (CBM) is a collective term for the business competencies, business components and business services and their relationships that together describe an enterprise or industry.

Business Component is a logical view of a part of an enterprise that includes the resources, processes, people, services, technology and know-how necessary to delivery for delivering some value to the rest of the organization.

Service Oriented Architecture (SOA) is an enterprise-scale information technology (IT) architecture providing IT agility to support business agility.

Service Category is a top-down concept where, oftentimes, one does not know the details yet; some general properties may be known and services that are needed may be suspected that may be further elaborated in this category.

Service Group is bottom up grouping of services based on the common cohesive set cohesive set characteristics.

Any Business is composed of Domains. A Domain is a logical grouping of business capabilities that provide related business functions and require similar skills and expertise.

A Domain can be broken down into Functional Areas. A Domain can provide a set of cohesive business functions and require similar skills and expertise.

A Business Process is a collection of interrelated tasks, which accomplish a particular goal.

Service Oriented Modeling and Architecture (SOMA) is an end-to end SOA development method aimed at enabling target business processes through the identification, specification, realization, implementation, and deployment of business-aligned services that form the Service-Oriented Architecture (SOA) foundation.

Service Model is an abstraction of the IT services implemented within an enterprise that supports the development of SOA solutions. It is used to conceive and document the design of the software services. It contains core elements of Service-Oriented Architecture. It is used as an input for implementation activities.

Candidate Service is an early stage of service life-cycle. Any service identified in early stage of the project will be considered as Candidate Service. In a typical SOA project, there will be several candidate services identified from various sources. But only a portion/subset of it makes it to real services. The real services are referred as Exposed Services in the service life-cycle.

Exposed Service is a service qualified for exposure.

Unified Modeling Language (UML) is a standardized general-purpose modeling language in the field of software engineering. UML includes a set of graphical notation techniques to create abstract models of specific systems, referred to as UML model.

SOMA-ME is an UML based SOA modeling tool for SOMA methodology. It extends IBM Rational Software Architect and IBM Rational Software Modeler.

Rational Software Architect is an advanced model-driven development tool. It leverages model-driven development with the UML for creating well-architected applications and services. Rational® is a registered trademark of International Business Machines Corporation.

Rational Software Modeler is a robust collaborative platform for visual modeling and design.

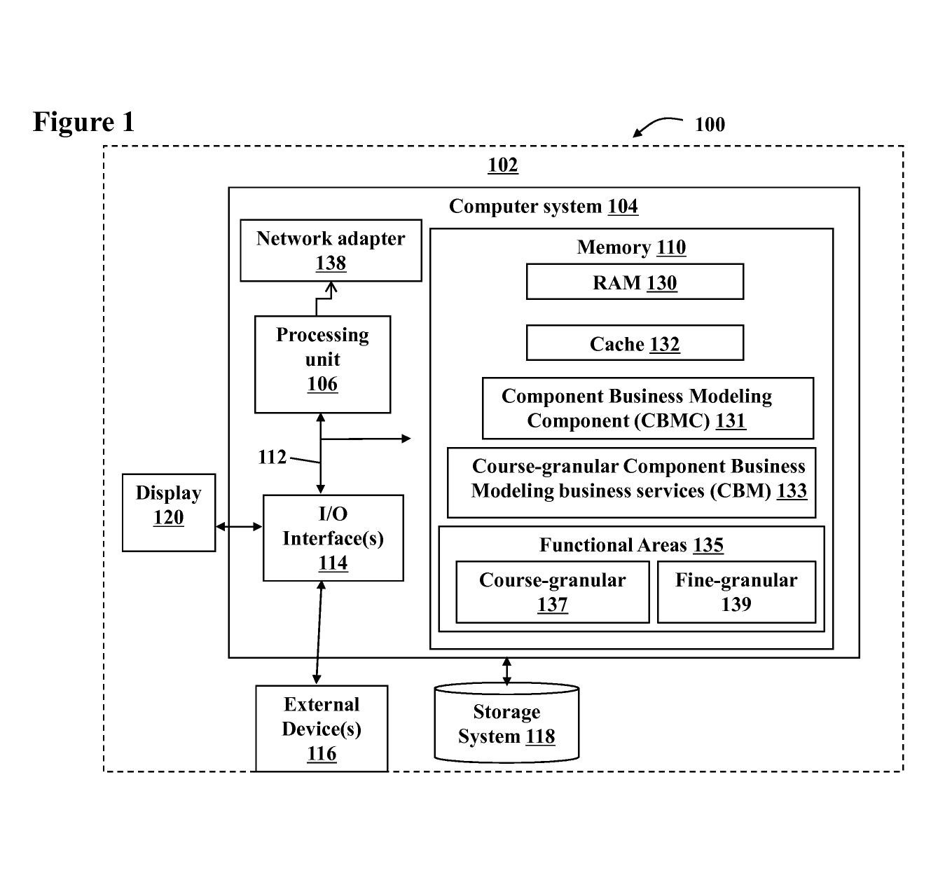

FIG. 1 shows a system 100 that may have a data processing system 102 suitable for implementing an embodiment of the present invention. Data processing system 102 may have a computer system 104 connected to a display 120, external device(s) 116 or other peripheral devices for providing a user an interface to computer system 104 being connected via I/O interface(s) 114. Computer system 104 may have an internal bus 112 for providing internal communication between such modules as processing unit 106, I/O interface(s) 114, network adapter 138 and memory 110. Memory 110 may have random access memory (RAM) 130, cache 132 and storage system 118 or other forms of memory. RAM may take the form of integrated circuits that allow stored data to be accessed in any order, that is, at random. Storage system 118 may take the form of tapes, magnetic discs and optical discs and are generally used for long term storage of data. Cache 132 is a memory for storing a collection of data-duplicating original values stored elsewhere or computed earlier, where the original data is expensive to fetch (owing to longer access time) or to compute, compared to the cost of reading the cache. In other words, a cache is a temporary storage area where frequently accessed data can be stored for rapid access. Once the data is stored in the cache, it can be used in the future by accessing the cached copy rather than re-fetching or re-computing the original data. A cache has proven to be extremely effective in many areas of computing because access patterns in typical computer applications have locality of reference. Computer system 104 may have a Component Business Modeling Component (CBMC) 131 as well as a Course-granular Component Business Modeling business services (CBM) 133, Functional Areas 135 that may have a course-granular functional area 137 and a fine-granular functional area 139.

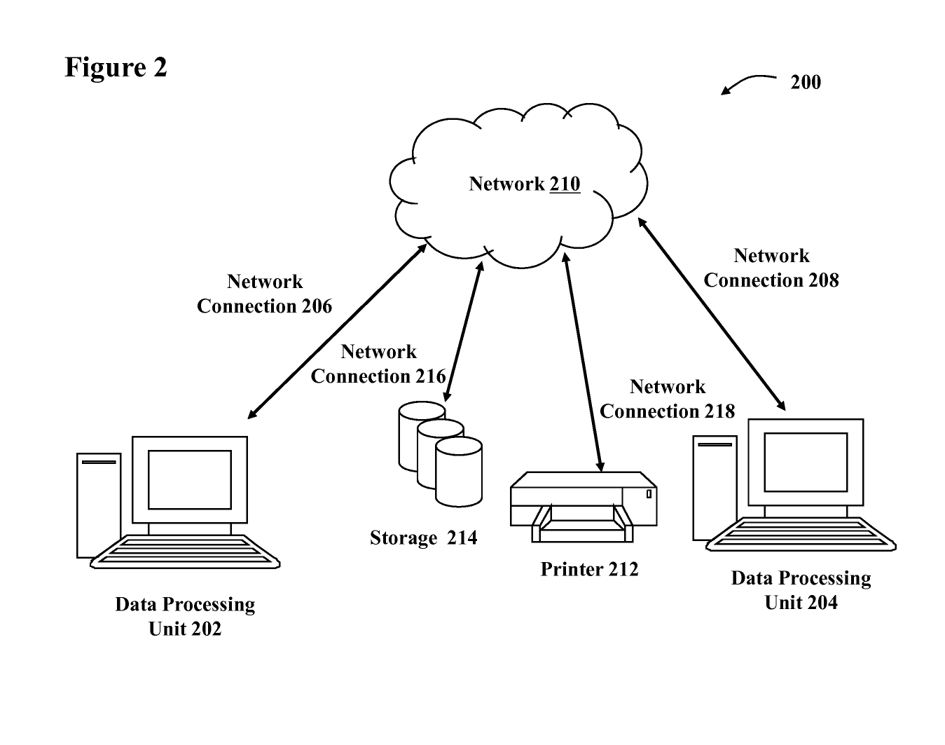

FIG. 2 shows a network system 200 for implementing an embodiment of the present invention. Network system 200 may have a network 210 or group of interconnected computers, such as data processing units 202, 204, via network connections 206, 208 and may be of the type, e.g., a local area network (LAN) or internetwork. Printer 212 and storage 214 may be connected to network 210 via network connections 216, 218. Basic network components may include network interface cards, repeaters, hubs, bridges, switches and routers. Data processing units 202, 204 may be computers such as web servers or personal computers, or other user agents. A web server generally has hardware and software that are responsible for accepting HTTP requests from clients (user agents such as web browsers), and serving them HTTP responses along with optional data contents, which usually are web pages such as HTML documents and linked objects (images, etc.). In this document, the term “web browser” is used but any application for retrieving, presenting, and traversing information resources on the Internet must be considered.

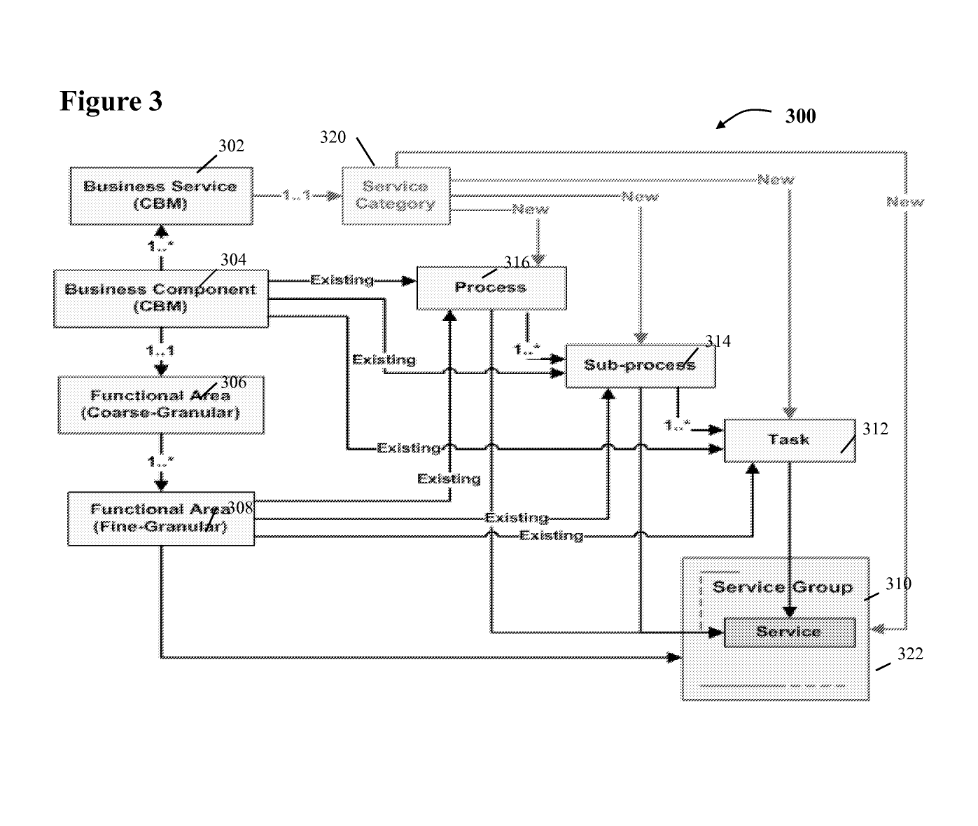

FIG. 3 illustrates a block diagram 300 where a Business Component (CBM) 304 has one or more Business Service (CBM) 302 and Functional Area (Course-Granular) 306. Business Component has one or more Business Services. Functional Area (Course-Granular) 306 may be connected to Functional Area (Fine-Granular) 308 may be connected to a Service Group 310 that may have one or more Service 322, to Process 316, to Sub-Process 314 and to Task 312. Business Processes, such as Process 316, to Sub-Process 314, are mapped to corresponding Business Components such as Service Group 310 having Service 322 and to Task 312. Business Service (CBM) 302 may be connected to Service Category 320. Service Category 320 may be connected to Process 316, to Sub-Process 314, to Task 312 and to Service Group 310.

Business Service 302 may be transformed as Service Category 320 (in a one-to-one mapping method). Business Processes, such as Process 316 or Sub-Process 314, may be mapped to Service Categories, such as Service 322 in Service Group 310. Service Groups 322 may be created from Service Categories 320. Services 322 may be identified from process maps and may be grouped by Service Categories 320 corresponding to Business Services 302.

In one scenario, a Business Component 304 has one or more Business Services 302 and Business Activities 518. Business Processes 314, 316 may be mapped to corresponding Business Activities 518.

Business Service 502 may be mapped to Business Activities 518 (1-to-Many mapping). Service Groups 510 may be created from Business Services 502. Services 520 identified from process maps may be grouped by Business Services 502.

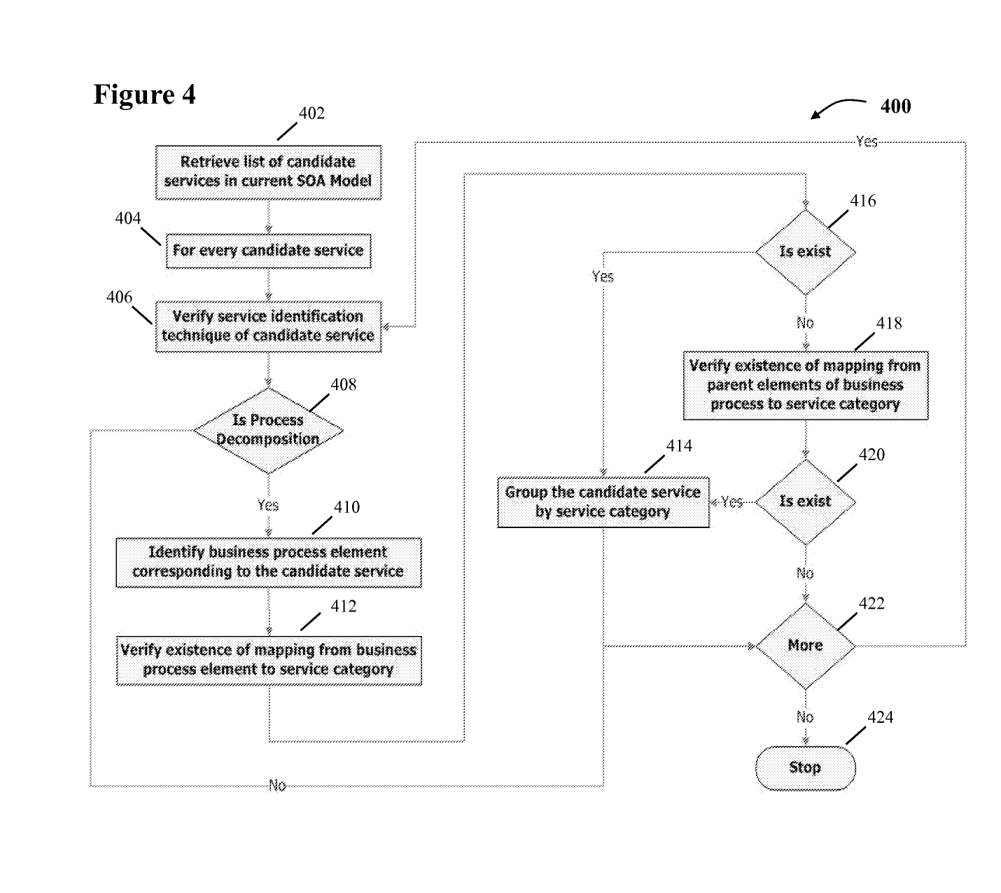

A method of the present invention is shown in FIG. 4 at 400. At 402, a list of candidate services in the current SOA model are retrieved. Every candidate service is examined at 404 and, at 406, the service identification technique is verified. At 408, it is determined whether the process has been decomposed. If so, at 410, a business process element corresponding to the candidate service is identified and, at 412, the existence of the mapping of the business process element to the service element is verified. At 416, it is determined that the existence of the mapping of the business process element to the service element is verified, at 414, the candidate service is grouped by service category. It is determined at 422 whether there is more and, if so, the method returns to step 406. At 416, it is determined that the existence of the mapping of the business process element to the service element is not verified, at 418, the existence of mapping from parent elements of business process to the service category.

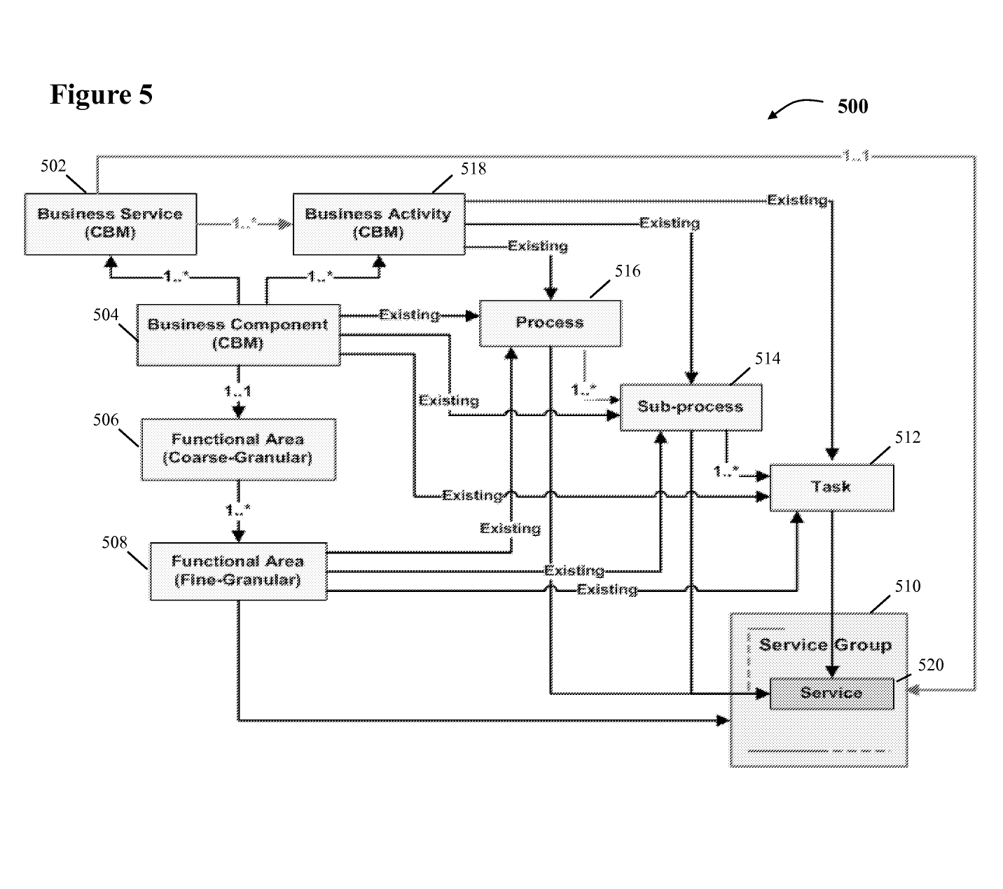

FIG. 5 shows a system and method 500 where Business Service (CBM) starting at 502 connecting to a Business Activity (CBM) 518 and to Service 520 in Service Group 510. Business Component (CBM) 504 may be connected to Business Service (CBM) 502 and to a Business Activity (CBM) 518, to Process 516 and to Functional Area (course granular) 506, which may be connected to Functional Area (fine granular) 508. Business Activity (CBM) 518 may also be connected to Process 516, to Sub-Process 514 and to Task 512. Business Component (CBM) 504 may also be connected to Process 516, to Sub-Process 514 and to Task 512. Functional Area (fine granular) 508 may also be connected to Process 516, to Sub-Process 514, to Task 512 and to Service 520 in Service Group 510.

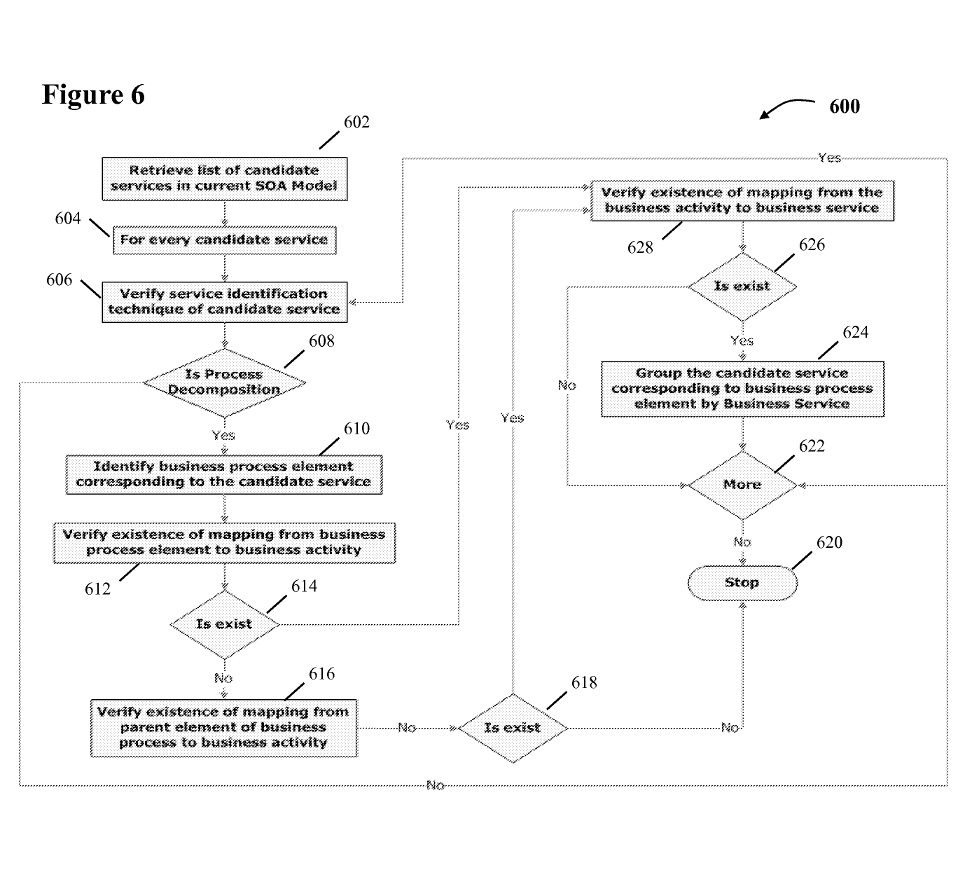

FIG. 6 shows a method of the present of the invention 600 that starts at 602 where the list of candidate services in the current SOA model are retrieved. At 604, each candidate service is examined and, at 606, the verification of identification of candidate service is conducted. At 608, it is determined whether the process is decomposed. If the process is decomposed, at 610, the business component corresponding to the candidate service is identified. At 612, the existence of mapping from business process element is verified. At 614, if it does not exist, at 616, the existence of mapping from a parent element of a business process to a business activity is verified. At 618, if it does not exist, the method ends at 620. If it does exist, at 628, the existence of mapping from a business service to a business activity is verified. At 626, if it does exist, at 624, the candidate service is grouped with the corresponding business process element with the business service. If it does not exist, at 622, it determined whether there is more. If not, the method ends at 620. At 614, if the existence of mapping from business process element is verified does exist, at 628, the existence of mapping from a business service to a business activity is verified.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion—to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for leveraging business services for Service Oriented Architecture (SOA) solution development in a system having a business component, such as a Component Business Modeling Component (CBMC), one or more business services, such as a Component Business Modeling (CBM) and a course-granular functional area, the business component may have one or more business services, the method comprising:
connecting the course-granular functional area to a fine-granular functional area;
connecting the fine-granular functional area to a service group that may have one or more service, to one or more processes, to one or more sub-processes and to one or more tasks; and
mapping the one or more processes and one or more sub-processes to one or more corresponding business components.

2. The method as defined in claim 1 further comprising mapping to one or more service groups having one or more services.

3. The method as defined in claim 2 further comprising connecting at least one business service to a task and to one or more service categories.

4. The method as defined in claim 3 further comprising connecting at least one service category to at least one business process, connecting at least one service category to the one or more sub-processes, to the one or more tasks and to the one or more service group.

5. A method for leveraging business services for Service Oriented Architecture (SOA) solution development in a system having a business component, such as a Component Business Modeling Component (CBMC), one or more business services, such as a Component Business Modeling (CBM), has one or more business services, such as CBM and a course-granular functional area, business component having one or more business services, the method comprising:
retrieving a list of candidate services in the current SOA model;
examining each candidate service;
verifying identification of candidate service;
decomposing the method; and
identifying the business component corresponding to the candidate service.

6. The method as defined in claim 5 further comprising verifying the existence of mapping from business process element to a parent element.

7. The method as defined in claim 6 further comprising verifying the existence of mapping from a parent element of a business process to a business activity.

8. The method as defined in claim 7 further comprising verifying the existence of mapping from a business service to a business activity is verified.

9. The method as defined in claim 8 further comprising grouping the candidate service with the corresponding business process element with the business service.

10. The method as defined in claim 9 further comprising mapping the existence from the business service to a business activity is verified.

11. A computer program product for implementing a method for leveraging business services for Service Oriented Architecture (SOA) solution development in a system having a business component, such as a Component Business Modeling Component (CBMC), has one or more course-granular Component Business Modeling business services (CBM) and a functional area, the business component may have one or more business services, the computer program product comprising:
a computer readable storage media;
program instructions to connect the course-granular functional area to fine-granular functional area;
program instructions to connect the fine-granular functional area to a service group that may have one or more service, to one or more processes, to one or more sub-processes and to one or more tasks; and
program instructions to map one or more business processes and one or more sub-processes to one or more corresponding business components, and wherein the program instructions are stored on the computer readable storage media.

12. The computer program product as defined in claim 11 further comprising program instructions to map to one or more service groups having one or more services.

13. The computer program product as defined in claim 12 further comprising program instructions to connect at least one business service to a task and to one or more service categories.

14. The computer program product as defined in claim 13 further comprising program instructions to connect at least one service category to at least one business process, to connect at least one service category to the one or more sub-processes, to the one or more tasks and to the one or more service group.

15. A method for deploying a computing infrastructure comprising integrating computer-readable code into a computing system, wherein the code in combination with the computing system is capable of performing a process of leveraging business services for a Service Oriented Architecture (SOA) model solution development in a system having a business component, such as a Component Business Modeling Component (CBMC), has one or more course-granular Component Business Modeling business services (CBM) and a course-granular functional area, the business component having one or more business services, the process comprising:
retrieving a list of candidate services in a current SOA model;
examining each candidate service;
verifying identification of a candidate service;
decomposing the method; and
identifying the business component corresponding to the candidate service.

16. The method as defined in claim 15 wherein the process further comprises verifying the existence of mapping from each business process element to a parent element.

17. The method as defined in claim 16 wherein the process further comprises verifying the existence of mapping from a parent element of a business process to a business activity.

18. The method as defined in claim 17 wherein the process further comprises verifying the existence of mapping from a business service to a business activity.

19. The method as defined in claim 18 wherein the process further comprises grouping the candidate service with the corresponding business process element with the business service.
